(19) United States
(12) Patent Application Publication
(10) Pub. No.: US 2014/0173709 A1
(43) Pub. Date: Jun. 19, 2014

(54) SECURE USER ATTESTATION AND AUTHENTICATION TO A REMOTE SERVER

(71) Applicants: AVIGDOR ELDAR, Jerusalem (IL); SURESH SUGUMAR, Bangalore (IN); CRAIG OWEN, Folsom, CA (US); ABDUL BAILEY, Tigard, OR (US)

(72) Inventors: AVIGDOR ELDAR, Jerusalem (IL); SURESH SUGUMAR, Bangalore (IN); CRAIG OWEN, Folsom, CA (US); ABDUL BAILEY, Tigard, OR (US)

(21) Appl. No.: 13/997,675

(22) PCT Filed: Dec. 16, 2011
(86) PCT No.: PCT/US11/65428

§ 371 Date: Jan. 24, 2014

(51) Int. Cl. H04L 29/06

(52) U.S. Cl. CPC H04L 63/04
USPC 726/7

(57) ABSTRACT

Secure authentication to a remote application operating on a remote server across a network includes detecting a login associated with the remote application; and in response to the detected login, offloading the login process to an isolated execution environment configured to receive a login request message from the browser application; identify confidential information stored in the secure memory storage and associated with the remote application; populate the login request message with the identified confidential data; transmit the populated login request message to the remote application; receive a login response message from the remote application upon successful login; and transmit the login response message to the browser application, wherein only the isolated execution environment can read and write to the secure memory storage.

### FIELD

The present disclosure relates to systems and methods for protecting confidential information, and more particularly, to systems and methods for secure user attestation and authentication.

### BACKGROUND

One method for a user to gain access to an application (e.g., a web application associated with a remote server or the like) includes the use of a username and a unique code (e.g., password, pin, or the like). In order to increase security, each web application should have a unique username and code; however, remembering which username/code belongs to each web application may become difficult for a user as the number of different applications increases. While some client platforms (e.g., personal computers and the like) may store a username/code associated with each web application, these usernames/codes may be compromised (e.g., stolen) by malware programs and the like.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a system block diagram of one exemplary embodiment consistent with the present disclosure;

FIG. 2 illustrates a system logic block diagram of one exemplary embodiment consistent with the present disclosure;

FIG. 3 illustrates a flowchart of operations of one exemplary embodiment consistent with the present disclosure; and

FIG. 4 illustrates a flowchart of operations of another exemplary embodiment consistent with the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure provides systems and methods for secure user attestation and authentication. For example, a client platform (such as, but not limited to, a desktop, a laptop, and/or a mobile computing device) includes an isolated execution environment (e.g., but not limited to, a management engine) and a browser application configured to securely login to a remote application (e.g., a web application operating on a remote server). Upon detecting a web-site requiring login, the browser application offloads the login process to a security engine running in the isolated execution environment. The security engine is configured to perform user verification and store and transmit login information. For example, the security engine may perform user verification by requiring the user to enter information prior to storing or transmitting login information. Once the security engine has verified the user, the security engine identifies login information associated with the particular web application (e.g., confidential information such as username, password, etc. which may be stored in secured memory) and transmits the identified login information to the web application by way of a login request. The security engine may protect the confidential information (e.g., by encrypting prior to transmission across the network to the remote server). If the login information (including the confidential information) is valid, the web application grants access to the client platform and the browser application resumes control as an authenticated user.

The system and method may therefore increase security by authenticating the end user to ensure that he has proper rights to access the confidential data stored on the client platform; and/or prevent unauthorized (e.g., malicious) access to end user confidential data stored on the client platform, thus maintaining usability and security. The system and method does not require a secure environment to be established within the browser application, but instead may be seamlessly integrated into a web application (e.g., an off-the-shelf web application) and may also allow a web application running on a remote server to continue to use existing password based authentication methods (i.e., the system and method does not require web applications and users to use a different authentication method). The system and method may keep confidential information protected from the operating system (OS) of the client platform, and release/transmit only the relevant confidential information to the web application (for example, using a secure HTTPS session or the like).

As used herein, the term “confidential information” or “confidential data” is intended to mean information or data related to an individual or entity which is not public and may be used to identify the user or entity. Examples of confidential information include, but are not limited to, username, password, personal identification number (PIN) or code, credit card number, social security number, date of birth, maiden name, birthplace, and the like. Additionally, as used herein, malicious software (or malware) is intended to mean programming (e.g., code, scripts, active content, and other software) designed to disrupt or deny operation, gather information that leads to loss of privacy or exploitation, gain unauthorized access to system resources, and other abusive behavior. Examples of malware include, but are not limited to, computer viruses, worms, trojan horses, spyware, dishonest adware, scareware, crimeware, and other malicious and unwanted software or program.

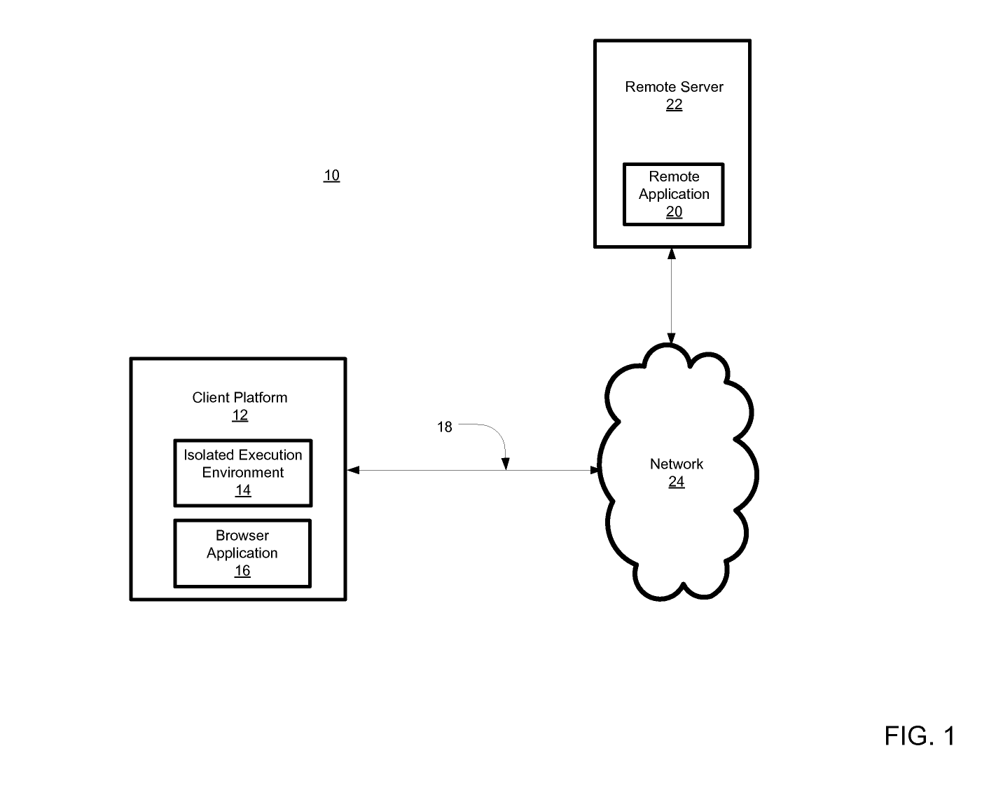

Turning now to FIG. 1, one embodiment of a system 10 consistent with the present disclosure is generally illustrated. The system 10 includes a client platform 12 including an isolated execution environment 14 and a browser application 16 configured to establish a communication link 18 with a remote application 20 (e.g., but not limited to, a web application) operating on a remote server 22 across a network 24.

The platform 12 may include, but is not limited to, a desktop computer, laptop computer, and/or mobile computing device (such as, but not limited to, smart phones (such as, but not limited to, a Blackberry™ smart phone, an iPhone™ smart phone, an Android™ smart phone, and the like), tablet computers (such as, but not limited to, an iPad™ tablet computer, PC-based tablet computers, and/or current or future tablet computers), and ultra-mobile personal computers).

As described in more detail herein, the isolated execution environment 14 is an execution environment that is configured to execute code independently and securely isolated from the rest of the client platform 12 such that the operating system (OS) and/or BIOS of the client platform 12 are unaware of the presence of the isolated execution environment 14 (e.g., it is hidden from the OS and basic input/output system (BIOS)). The isolated execution environment 14 may be configured to perform user verification/attestation, store confidential data, and process login requests offloaded from the browser application 16.

The browser application 16 may include any application configured to allow navigation (e.g., for retrieving, presenting, and traversing information resources) between the client platform 12 and the remote server 22 across a computer network 24 (e.g., but not limited to, the World Wide Web). Examples of browser applications 16 include, but are not limited to, browser applications such as Internet Explorer™ available from Microsoft Corp.™, Firefox™ available from Mozilla Corp.™, Google Chrome™ available from Google Inc.™, Safari™ available from Apple Inc.™, and Opera™ available from Opera Software™.

The remote application 20 may include any application running on remote server 22 which utilizes end user authentication (e.g., login). Examples of remote applications 20 include, but are not limited to, email accounts (e.g., Gmail™, Yahoomail™, Hotmail™, AOL™, etc.), social networking applications (e.g., Facebook™, Twitter™, etc.), commercial transaction applications (e.g., eBay™, PayPal™, banking applications, etc.), and the like. The network 24 may include a computer network such as, but not limited to, a local area network (LAN), wide area network (WAN), personal area network (PAN), virtual private network (VPN), internet, and the like.

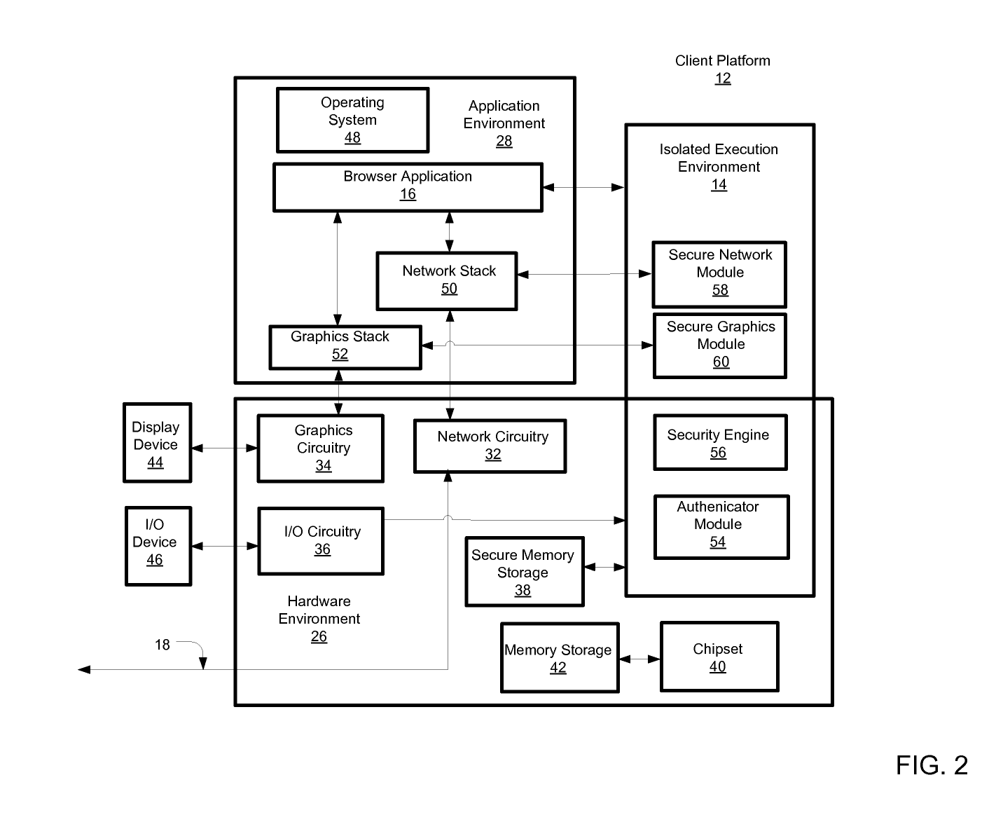

Turning now to FIG. 2, one embodiment of a client platform 12 is generally illustrated. The client platform 12 includes a hardware environment/platform 26, an application environment/platform 28, and an isolated execution environment 14. While the isolated execution environment 14 is illustrated as being part of the client platform 12, the isolated execution environment 14 may be located externally from the client platform 12 as discussed herein.

The hardware environment 26 includes network circuitry 32, graphics circuitry 34, input/output circuitry 36, secure memory 38, chipset 40, and memory 42. The network circuitry 32 (such as, but not limited to, a network interface controller (NIC)) is configured to establish a communication link 18 across one or more networks 24 with the remote server 22. For example, network circuitry 32 may be configured to establish a communication link 18 in accordance with IEEE standard 802.3 or the like with remote server 22. It may be appreciated, however, that this is only one example and that the present disclosure is not thus limited.

Graphics circuitry 34 (such as, but not limited to, a graphics interface controller) is configured to generated an image to be displayed on display device 44. Input/output circuitry 36 (such as, but not limited to, an I/O controller) is configured to receive input from an input/output device 46 (such as, but not limited to, a keyboard, mouse, tracker, touch screen, or the like). Secure memory 38 is configured to store confidential information and/or data. Only the isolated execution environment 14 may read and/or write data to/from secure memory 38. Examples of secure memory 38 include, but are not limited to, dynamic random-access memory (DRAM), flash memory, and the like.

The chipset 40 may include one or more processor units or cores (not shown for clarity) and associated memory 42 may include any memory which is accessible by chipset 40.

The application environment 28 includes an operating system 48, browser application 16, one or more network stacks 50, and one or more graphics stacks 52. The operating systems 48 may include, but is not limited to, operating systems based on Windows™, Unix, Linux™, Macintosh™, and operating systems embedded on a processor.

As used herein, the isolated execution environment 14 is intended to mean an execution environment that is configured to execute code independently and securely isolated from the rest of the client platform 12 such that the OS and/or BIOS of the client platform 12 are unaware of the presence of the isolated execution environment 14 (e.g., the isolated execution environment 14 is hidden from the OS and BIOS). The secure environment may be established by storing the security engine firmware in memory that is not writable by the host processor and/or OS. As such, the isolated execution environment 14 is further configured to prevent software running on the remainder of the client platform 12 (e.g., host chipset 40) from performing operations that would alter, modify, read, or otherwise affect the code store or executable code that is running in the isolated execution environment 14. Examples of an isolated execution environment 14 include, but are not limited to, dedicated hardware which is independent of the remaining hardware of the platform 12 or a dedicated Virtual Machine (VM) which is distinct from the OS hosting the browser application 16. For example, one embodiment of an isolated execution environment 14 consistent with the present disclosure that may be used with the present disclosure includes, but is not limited to, the Intel™ Management Engine (Intel® ME).

As discussed in greater detail herein, the isolated execution environment 14 is configured to authenticate a user (e.g., determine that a specific user is present and operating the client platform 12) and may protect confidential information from unauthorized access (e.g., prevent access to confidential information from the operating system 48 and/or any malicious software (not shown) running on the client platform 12). The isolated execution environment 14 includes an authenticator module 54, a security module/engine 56, a secure network module 58, and/or a secure graphics module 60. In particular, the authenticator module 54 may be configured to establish an authenticated session (i.e., ensure that a specific user is present and operating the client platform 12) between the user and the isolated execution environment 14 (e.g., the security engine 56). For example, the authenticator module 54 may be configured to receive authentication information entered by the user. The authentication information may include, but is not limited to, a username and password/code, biometric information (e.g., retinal scan, fingerprint scan, or the like), digital information (e.g. stored on a smart card, chip card, integrated circuit card, or the like), etc. Optionally, the secure graphics module 60 may generate a secure image using graphics stack 52 and/or graphics circuitry 34 for output on the display device 44. The secure image may include a random pattern which only the end user at the client platform 12 can read on the display device 44. The user may then input the pattern (i.e., authentication information) to the authenticator module 54. If the authentication information corresponds with data (e.g., matches) associated with the isolated execution environment 14 (e.g., stored within the secure memory storage 38), then the authenticator module 54 may establish an authenticated session between the user and the isolated execution environment 14 (e.g., the security module/engine 56).

The authenticator module 54 may also be configured to create a new user account associated with the isolated execution environment 14. In particular, the authenticator module 54 may require the user to enter security data (e.g., using I/O circuitry 36) in order to grant access to create a new user account. The authenticator module 54 then compares the security data to data stored within the isolated execution environment 14 (e.g., secure memory storage 38), and if the security data matches, the authenticator module 54 may create a new user account. The user may enter confidential information about the user (e.g., using I/O circuitry 36) which may be stored in the secure memory storage 38 and associated with the user account.

In practice, when the browser application 16 detects or identifies a login form associated with a remote application 20, the login process is offloaded from the browser application 16 to the isolated execution environment 14 (e.g., the security engine 56). For example, the location of the remote application 20 running on the remote server 22 (e.g., the web-site URL), a partially processed request message (e.g., a partially processed HTTP request message such as, but not limited to, a HTTP POST request message), and all the necessary remote application/remote server information (with the exception of confidential data) may be transmitted to the security engine 56 (e.g., from the browser application 16). An interface may be provided to allow communication between the security engine 56 and the browser application 16. One example of an interface may include a host embedded controller interface (HECI) bus. The HECI bus allows the Host OS 48 and/or the browser application 16 to communicate directly with the isolated execution environment 14 (e.g., security engine 56). The bus may include a bi-directional, variable data-rate bus configured to enable the Host OS 48/browser application 16 and isolated execution environment 14 to communicate system management information and events in a standards-compliant way. Alternatively, the System Management Bus (SMBus) may be used.

After an authenticated session has been established with the isolated execution environment 14 as described herein, the security engine 56 may identify/determine whether the login form associated with a remote application 20 is currently registered with the user account in the isolated execution environment 14. For example, the security engine 56 may search the secure memory storage 38 for the user's confidential data associated with the remote application 20 and/or remote server 22 (e.g., using the web-site URL). The secure memory storage 38 may include one or more user-profile databases which each associate a user's confidential data with the remote application 20 and/or remote server 22 (e.g., web-site URL).

If the login form associated with a remote application 20 is not currently registered with the user account in the isolated execution environment 14, then the security engine 56 may offer the user to register the login form associated with a remote application 20. If the user decides to register the login form associated with the remote application 20, then the user may enter the confidential data associated with the remote application 20 (e.g., by entering the confidential data into the browser application 16) and the security engine 56 may store the confidential data in a user-profile database within the secure memory storage 38 (e.g., after the browser application 16 detects a successful login with the remote application 20).

If the login form associated with a remote application 20 is already registered with the user account in the isolated execution environment 14, then the security engine 56 may be configured to capture the request message (e.g., a HTTP request message) generated by the browser application 16, for example, before the request message is transmitted down to the network stack 50. The security engine 56 may then populate the message request with the end user confidential data associated with the login of the remote application 20 (stored in the user-profile in the secure memory storage 38), and transmit the populated message request (including the confidential data) to the remote application 20.

Optionally, the secure network module 58 may establish a secure communication pipe/link (e.g., using one or more cryptographic protocols that provide communication security over the internet) with the remote application 20 on the remote server 22, for example, using the network stack 50 and the network circuitry 32. The secure communication pipe/link may include, but is not limited to, secure sockets layer (SSL), transport layer security (TLS), and/or hypertext transfer protocol secure (HTTPS), secure hypertext transfer protocol (S-HTTP), or the like.

If the login information (e.g., confidential data) is valid, the remote application 20/remote server 22 generates a session cookie and sends the session cookie within a message response (e.g., a HTTP response, using the HTTP set-cookie header). Upon successful login, the security engine 56 may receive the session cookie from the remote server 22, and return control (including the session cookie) back to the browser application 16. The browser application 16 may then update the website cookie information with the provided session cookie, complete the processing of the HTTP request (e.g., process a redirect request, and load HTML content) and function normally. The user may therefore continue browsing the remote application 20 and remote server 22 with an authenticated browsing session as usual and without having to enter any confidential data.

Optionally, whenever the user browses into a recognized web-site (i.e., a remote application 20 which is associated with the user account) which requires a login process, the browser application 16 detects this condition and triggers the security engine 56 to perform a user verification and/or attestation. In particular, the security engine 56 may be configured to require the user to enter information to authenticate the user and/or ensure that the user is still present. For example, the security engine 56 may cause the authenticator module 54 and/or the secure graphics module 60 to generate a random pattern which the user must enter as described herein. The security engine 56 may also cause the authenticator module 54 to require the user to enter data to authenticate the user (e.g., biometric data, password, smart card/circuitry, or the like). The security engine 56 may also be configured to periodically and/or randomly require user verification and/or attestation.

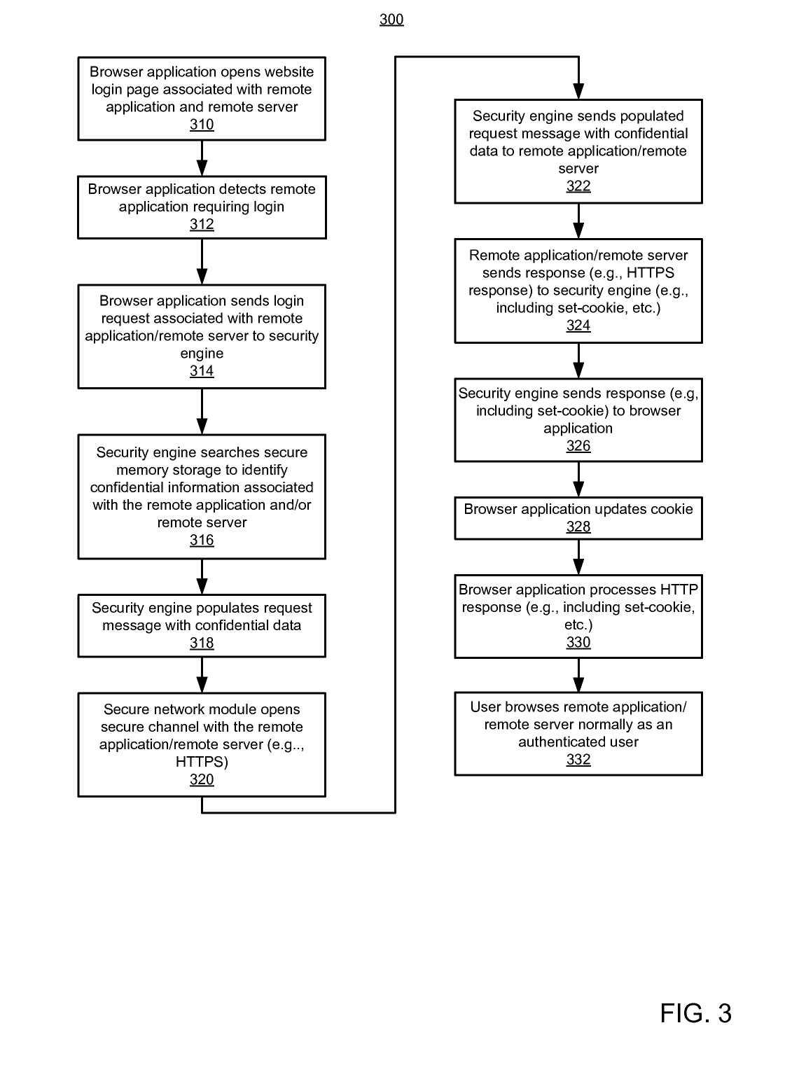

Turning now to FIG. 3, a flowchart of operations for a method 300 consistent with one embodiment of the present disclosure is generally illustrated. The method 300 may be performed after the user has established an authenticated session with the isolated execution environment. In particular, the user may open a website having a login page which is associated with a remote server using the browser application (operation 310). The browser application may then detect a login process (operation 312) and may then offload the login process to the security engine. For example, the browser application may send login request (e.g., URL, partially processed HTTP request message, for example, a HTTP POST, etc.) to the security engine (operation 314). The security engine may optionally perform user verification.

Upon receipt of the login request, the security engine may search the secure memory storage to determine if the remote application/remote server is associated with a user profile stored in the secure memory storage, and if so, identify any confidential information associated with the remote application/remote server (operation 316). If the security engine identifies a user profile associated with the remote application/remote server, then the security engine populates the login request message (e.g., HTTP request) with the relevant confidential data (operation 318). Optionally, the secure network module establishes a secure channel (e.g., a SSL session) with the remote application/remote server (operation 320). The security engine sends the populated request message (which includes the confidential data) to the remote application/remote server (e.g., while sending the HTTP payload within the SSL (e.g., HTTPS)) (operation 322).

If the login information (e.g., the confidential data) is valid, the remote application/remote server generates a session cookie and transmits the session cookie within a response (e.g., a HTTP response using the HTTP set-cookie header) and the user is logged-in (operation 324). The security engine may forward the HTTP response to the browser application (operation 326). The browser application may then update the cookie information with the provided session cookie (operation 328) and completes processing of the HTTP response (e.g., process a redirect request, load HTML content, etc.) (operation 330). The browser application is thus logged-in to the remote application/remote server and the user may continue browsing normally as an authenticated user (operation 332).

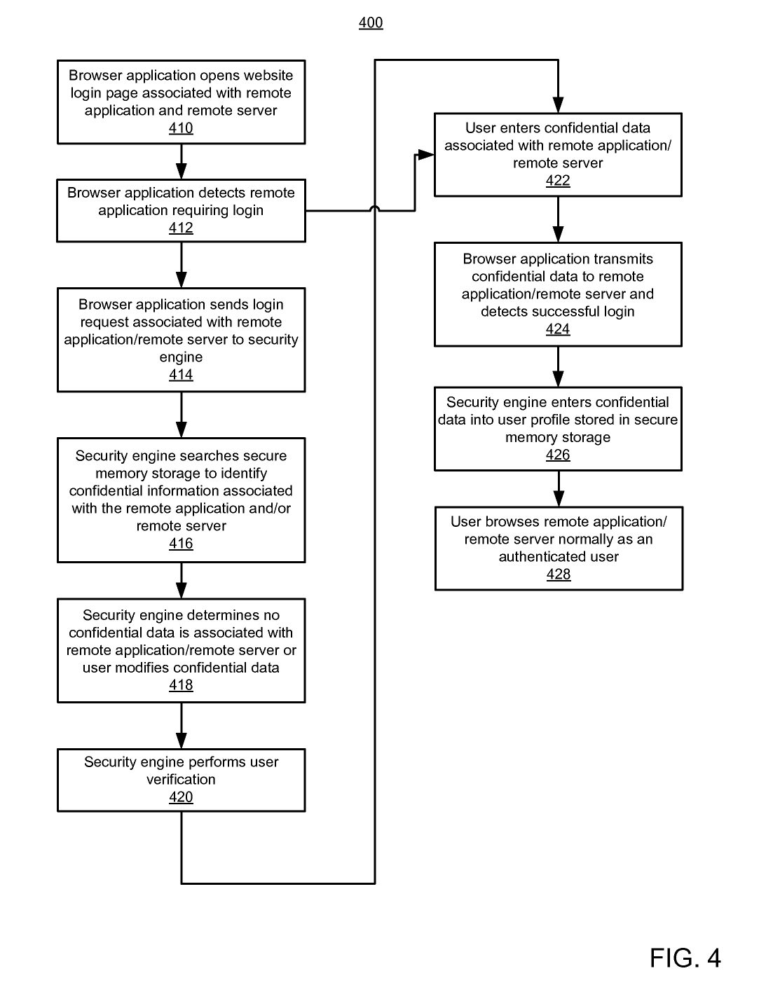

With reference to FIG. 4, a flowchart of operations for a method 400 for enrollment/registration of a remote application/remote server consistent with one embodiment of the present disclosure is generally illustrated. The method 400 may be performed after the user has established an authenticated session with the isolated execution environment. In particular, the user may navigate to a website login page associated with a remote server using the browser application (operation 410). The browser application may then detect a login process (operation 412) and may then offload the login process to the security engine. For example, the browser application may be configured to keep track of which web-pages have already been “registered” previously with the security engine. When a user accesses a login-page, the web-browser may check if confidential information was previously registered. According to at least one embodiment, however, the browser application may not have access to the actual information, instead the browser application may be configured to determine if confidential information is associated with the web-page. If the browser application determines that no confidential information is associated with the web-page, then the browser application will request the user to enter the login information. The confidential information may then be stored by the security-engine (see, for example, operation 422 described below).

Alternatively, upon detection of a login page, the browser application may send login request (e.g., URL, partially processed HTTP request message, for example, a HTTP POST, etc.) to the security engine (operation 414). The security engine may optionally perform user verification. Upon receipt of the login request, the security engine may search the secure memory storage to determine if the remote application/remote server is associated with a user profile stored in the secure memory storage (operation 416). If the security engine does not identify a user profile associated with the remote application/remote server or if the user decides to modify or update the confidential data associated with the remote application/remote server (operation 418), then the security engine may perform user verification as described herein (operation 420). The user may enter confidential data associated with the remote application/remote server (operation 422). The browser application may transmit the confidential data to the remote application/remote server and detect whether the login was successful (operation 424).

The security engine may store the confidential data associated with the remote application/remote server in a user profile of a secure memory storage (operation 426). The browser application may therefore be logged in to the remote application/remote server and the user may continue browsing normally as an authenticated user (operation 428).

While FIGS. 3 and 4 illustrate method operations according to various embodiments, it is to be understood that in any embodiment not all of these operations are necessary. Indeed, it is fully contemplated herein that in other embodiments of the present disclosure, the operations depicted in FIGS. 3 and 4 may be combined in a manner not specifically shown in any of the drawings, but still be fully consistent with the present disclosure. Thus, claims directed to features and/or operations that are not exactly shown in one drawing are deemed within the scope and content of the present disclosure.

The systems and methods according to at least one embodiment of the present disclosure may therefore enable users and remote applications/remote servers (e.g., web-sites) to continue to use existing username/password based authentication methods. Unlike other techniques, the systems and methods according to at least one embodiment of the present disclosure may protect confidential data (e.g., passwords, etc.) from malware at any given time, for example, even while a user is actively using a browser application. The systems and methods according to at least one embodiment of the present disclosure may prevent other applications (e.g., the OS or other applications) from having access (e.g., reading and/or writing) to confidential data, and may release only the relevant confidential data associated with a remote application/remote server that the user approves (e.g., using a secure HTTPS session).

The systems and methods according to at least one embodiment of the present disclosure may provide a user authentication/attestation in order for the isolated execution environment to grant access to the confidential data. The user authentication/attestation may include entry of a password, private identification number, biometric data, random pattern, and/or the like. The systems and methods according to at least one embodiment of the present disclosure may also eliminate the need to establish a secure environment within the browser application, but rather instead may utilize an off-the-shelf browser application and OS networking capabilities to improve the security and usability of a browser based login flow.

Embodiments of the methods described herein may be implemented in a system that includes one or more storage mediums (e.g., tangible machine-readable medium) having stored thereon, individually or in combination, instructions that when executed by one or more processors perform the methods. Here, the processor may include, for example, a system CPU (e.g., core processor) and/or programmable circuitry. Thus, it is intended that operations according to the methods described herein may be distributed across a plurality of physical devices, such as processing structures at several different physical locations. Also, it is intended that the method operations may be performed individually or in a subcombination, as would be understood by one skilled in the art. Thus, not all of the operations of each of the flow charts need to be performed, and the present disclosure expressly intends that all subcombinations of such operations are enabled as would be understood by one of ordinary skill in the art.

Certain embodiments described herein may be provided as a tangible machine-readable medium storing computer-executable instructions that, if executed by the computer, cause the computer to perform the methods and/or operations described herein. The tangible computer-readable medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The computer may include any suitable processing platform, device or system, computing platform, device or system and may be implemented using any suitable combination of hardware and/or software. The instructions may include any suitable type of code and may be implemented using any suitable programming language.

As used in any embodiment herein, the term “module” refers to software, firmware and/or circuitry configured to perform the stated operations. The software may be embodied as a software package, code and/or instruction set or instructions, and “circuitry”, as used in any embodiment herein, may comprise, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), etc.

Although some claim elements may be labeled for clarity, it will be appreciated that in some implementations, the order of performance of the claim elements may be varied.

Thus, in one embodiment the present disclosure provides an apparatus including an isolated execution environment configured to: receive a login request message from a browser application generated by a remote application executing on a remote server; identify confidential information stored in secure memory storage and associated with the remote application; populate the login request message with the identified confidential data; transmit the populated login request message to the remote application; receive a login response message from the remote application upon successful login; and transmit the login response message to the browser application; wherein only the isolated execution environment can read and write to the secure memory storage.

In another embodiment, the present disclosure provides a system including a browser application, a hardware environment, secure memory storage configured to store confidential data, and an isolated execution environment. The browser application is configured to detect a login associated with a remote application operating on a remote server across a network and to offload the login. The hardware environment includes at least one processor configured to execute the browser application, and network circuitry configured to establish a communication link with the remote application on the remote server. The isolated execution environment is configured to execute code independently and securely isolated from the hardware environment. The isolated execution environment is further configured to: receive a login request message from the browser application, the login request message generated by the remote application; identify confidential information stored in the secure memory storage and associated with the remote application; populate the login request message with the identified confidential data; transmit the populated login request message to the remote application; receive a login response message from the remote application upon successful login; and transmit the login response message to the browser application; wherein only the isolated execution environment can read and write to the secure memory storage.

In yet another embodiment, the present disclosure provides a method including: receiving, at an isolated execution environment, a login request message from a browser application, the login request message generated by a remote application operating on a remote server across a network; identifying confidential information stored in a secure memory storage accessible only by the isolated execution environment, the confidential information associated with the remote application; populating the login request message with the identified confidential data; transmitting the populated login request message from the isolated execution environment to the remote application; receiving a login response message from the remote application upon successful login; and transmitting the login response message from the isolated execution environment to the browser application.

In yet a further embodiment, the present disclosure provides at least one computer accessible medium storing instructions which, when executed by a processor associated with an isolated execution environment, result in the following operations comprising: receiving a login request message from a browser application, the login request message generated by a remote application operating on a remote server across a network; identifying confidential information stored in a secure memory storage accessible only by the isolated execution environment, the confidential information associated with the remote application; populating the login request message with the identified confidential data; transmitting the populated login request message to the remote application; receiving a login response message from the remote application upon successful login; and transmitting the login response message to the browser application.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

1-19. (canceled)

20. An apparatus comprising:
an isolated execution environment configured to:
receive a login request message from a browser application generated by a remote application executing on a remote server;
identify confidential information stored in secure memory storage and associated with said remote application;
populate said login request message with said identified confidential data;
transmit said populated login request message to said remote application;
receive a login response message from said remote application upon successful login; and
transmit the login response message to the browser application;
wherein only said isolated execution environment can read and write to said secure memory storage.

21. The apparatus of claim 21, wherein said isolated execution environment further comprises an authenticator module configured to perform user verification including comparing a passcode entered by a user with a passcode stored in said secure memory storage.

22. The apparatus of claim 21, wherein said isolated execution environment further comprises a secure graphics module configured to generate a pattern to be portrayed on a display device, wherein said authenticator module is configured to perform user verification including comparing data entered by a user with said pattern.

23. The apparatus of claim 21, wherein said isolated execution environment further comprises a secure network module configured to:
establish a secure session with said remote application on said remote server;
transmit said populated login request message to said remote application over said secure session; and
receive said login response from said remote application.

24. The apparatus of claim 21, wherein said login response message comprises a session cookie.

25. The apparatus of claim 21, wherein if said isolated execution environment determines that no confidential information is stored in said secure memory storage and associated with said remote application, said isolated execution environment is further configured to receive new confidential information and store said new confidential information in said secure memory storage.

26. A system comprising:
a browser application configured to detect a login associated with a remote application operating on a remote server across a network and to offload said login;
a hardware environment comprising at least one processor configured to execute said browser application, and network circuitry configured to establish a communication link with said remote application on said remote server;
secure memory storage configured to store confidential data; and
an isolated execution environment configured to execute code independently and securely isolated from said hardware environment, said isolated execution environment configured to:
receive a login request message from said browser application, said login request message generated by said remote application;
identify confidential information stored in said secure memory storage and associated with said remote application;
populate said login request message with said identified confidential data;
transmit said populated login request message to said remote application;
receive a login response message from said remote application upon successful login; and
transmit the login response message to the browser application;
wherein only said isolated execution environment can read and write to said secure memory storage.

27. The system of claim 26, wherein said isolated execution environment further comprises an authenticator module configured to perform user verification including comparing a passcode entered by a user with a passcode stored in said secure memory storage.

28. The system of claim 26, wherein said isolated execution environment further comprises a secure graphics module configured to generate a pattern to be portrayed on a display device, wherein said authenticator module is configured to perform user verification including comparing data entered by a user with said pattern.

29. The system of claim 26, wherein said isolated execution environment further comprises a secure network module configured to:
establish a secure session with said remote application on said remote server;
transmit said populated login request message to said remote application over said secure session; and
receive said login response from said remote application.

30. The system of claim 26, wherein said login response message comprises a session cookie.

31. The system of claim 26, wherein if said isolated execution environment determines that no confidential information is stored in said secure memory storage and associated with said remote application, said isolated execution environment is further configured to receive new confidential information and store said new confidential information in said secure memory storage.

32. The system of claim 26, wherein said browser application is further configured to determine if any confidential information is associated with said remote application, and if not, then said browser application is further configured to receive new confidential information, and wherein said isolated execution environment is further configured to store said new confidential information in said secure memory storage.

33. A method comprising:
receiving, at an isolated execution environment, a login request message from a browser application, said login request message generated by a remote application operating on a remote server across a network;
identifying confidential information stored in a secure memory storage accessible only by said isolated execution environment, said confidential information associated with said remote application;
populating said login request message with said identified confidential data;
transmitting said populated login request message from said isolated execution environment to said remote application;
receiving a login response message from said remote application upon successful login; and
transmitting the login response message from said isolated execution environment to the browser application.

34. The method of claim 33, further comprising:
establishing a secure session with said remote application on said remote server; and
transmitting said populated login request message from said isolated execution environment to said remote application over said secure session.

35. The method of claim 33, further comprising:
performing user verification, via said isolated execution environment, including comparing a passcode entered by a user with a passcode stored in said secure memory storage.

36. The method of claim 33, further comprising:
generating a pattern using said isolated execution environment to be portrayed on a display device; and
comparing data entered by a user with said pattern using said isolated execution environment.

37. The method of claim 33, further comprising:
establishing a secure session with between said isolated execution environment and said remote application on said remote server;
transmitting said populated login request message from said isolated execution environment to said remote application over said secure session; and
receiving said login response at said isolated execution environment from said remote application.

38. The method of claim 33, further comprising:
if no confidential information is stored in said secure memory storage and associated with said remote application, then receiving new confidential information and storing said new confidential information in said secure memory storage.

39. The method of claim 38, further comprising:
determining, via said isolated execution environment, if any confidential information is associated with said remote application, and if not, then receiving said new confidential information and storing said new confidential information in said secure memory storage by said isolated execution environment.

40. The method of claim 38, further comprising:
determining, via said browser application, if any confidential information is associated with said remote application, and if not, then receiving new confidential information via said browser application; and
storing said new confidential information in said secure memory storage by said isolated execution environment.

41. At least one computer accessible medium storing instructions which, when executed by a processor associated with an isolated execution environment, result in the following operations comprising:
receiving a login request message from a browser application, said login request message generated by a remote application operating on a remote server across a network;
identifying confidential information stored in a secure memory storage accessible only by said isolated execution environment, said confidential information associated with said remote application;
populating said login request message with said identified confidential data;
transmitting said populated login request message to said remote application;
receiving a login response message from said remote application upon successful login; and
transmitting the login response message to the browser application.

42. The at least one compute accessible medium of claim 41, wherein said instructions that when executed by said processor result in the following additional operations comprising:
generating a pattern to be portrayed on a display device; and
comparing data entered by a user with said pattern.

43. The at least one compute accessible medium of claim 41, wherein said instructions that when executed by said processor result in the following additional operations comprising:
establishing a secure session with said remote application on said remote server;
transmitting said populated login request message to said remote application over said secure session; and
receiving said login response from said remote application.

44. The at least one compute accessible medium of claim 41, wherein said instructions that when executed by said processor result in the following additional operations comprising:
if said isolated execution environment determines that no confidential information is stored in said secure memory storage and associated with said remote application, than receive new confidential information and store said new confidential information in said secure memory storage.
